(19) United States
(12) Patent Application Publication
(10) Pub. No.: US 2003/0224087 A1
(43) Pub. Date: Dec. 4, 2003

(54) Chewing gum including ingredients of mulberrry leaf

(76) Inventor: Young Jik Lee, Choongchungbuk-do (KR)

Correspondence Address: KNOBBE MARTENS OLSON & BEAR LLP, 2040 MAIN STREET, FOURTEENTH FLOOR, IRVINE, CA, 92614, US

(21) Appl. No.: 10/413,439

(22) Filed: Apr. 11, 2003

(30) Foreign Application Priority Data
Apr. 13, 2002 (KR) 10-2002-0020256

(51) Int. Cl. A23G 3/30

(52) U.S. Cl. 426/3

(57) ABSTRACT

Disclosed is a chewing gum including functional ingredients of mulberry leaf, allowing uptake of the ingredients of mulberry leaf in great quantities. Also disclosed is a process for preparing the chewing gum. The chewing-gum includes the functional ingredients of mulberry leaf of the invention comprises: 15-30%(w/w) of gum base, 60-80%(w/w) of sugar alcohol, 0.1-0.5%(w/w) of tenderizer, 0.1-1.0%(w/w) of moisturizer, 0.1-0.5%(w/w) of emulsifier, 0.5-2.5%(w/w) of flavoring agent, 0.01-10.0%(w/w) of the functional ingredients of mulberry leaf, and 0.1-2.0%(w/w) of concentrated fruit juice. The chewing gum can be practically applied for the diet food and substitute food for the patients suffering from constipation, diabetes and hypertension.

### BACKGROUND OF THE INVENTION

1. Field of the Invention

The present invention relates to food having nutritional and certain pharmacological effects. More specifically, the present invention relates to chewing gum having such effects.

2. Description of the Related Art

Recently, many people have focused on health-care as the matter of major concern, and meal management has been regarded as the most preferred way of pursuing good health. However, with the improvement of economic level, the life style gave undue value to palatability instead of nutrition, which disrupts nutritional balance, and the problems of obesity by taking high caloric food have played as an obstacle in the public health. Though various health foods have been developed in order to overcome these problems, the conventional foods have shortcomings that they cannot be taken as a staple food because of their expensive nature.

### SUMMARY OF THE INVENTION

One aspect of the present invention provides a chewing gum. One embodiment of the chewing gum comprises a gum base and mulberry leaf ingredients in a form of an extract of mulberry leaf, powder of dried mulberry leaf or a mixture thereof. In the chewing gum, the mulberry leaf ingredients are mixed with the gum base. The chewing gum contains substantially no sugar. The extract of mulberry leaf is in a form of liquid or powder. The gum base has a weight from about 15% to about 30% of the total weight of the chewing gum. The mulberry leaf ingredients has a weight from about 0.01% to about 10% of the total weight of the chewing gum.

The embodiment of chewing gum further comprises sugar alcohol. The sugar alcohol is selected from the group consisting of xylitol, maltitol, sorbitol and isomalt. The sugar alcohol has a weight from about 60% to about 80% of the total weight of the chewing gum. The chewing gum further comprises one or more selected from the group consisting of a tenderizer, a moisturizer, an emulsifier, a flavoring agent and fruit juice. The mulberry leaf ingredients comprise one or more selected from the group consisting of γ-amino butyric acid (GABA), rutin and deoxynojirimycin (DNJ). The mulberry leaf ingredients comprises one or more selected from the group consisting of alanine, aspartic acid, serine, tyrosine, calcium, iron, phosphor, sodium and potassium.

Another embodiment of chewing gum comprises a gum base; and one or more selected from the group consisting of γ-amino butyric acid (GABA), rutin and deoxynojirimycin (DNJ). The chewing gum further comprises one or more selected from the group consisting of alanine, aspartic acid, serine, tyrosine, calcium, iron, phosphor, sodium and potassium.

Still another embodiment of chewing gum comprises a gum base; and means for providing functional ingredients of mulberry leaf. The functional ingredients comprise one or more selected from the group consisting of γ-amino butyric acid (GABA), rutin and deoxynojirimycin (DNJ). The functional ingredients comprises one or more selected from the group consisting of alanine, aspartic acid, serine, tyrosine, calcium, iron, phosphor, sodium and potassium.

A still further embodiment of chewing gum is the one produced by the method described below.

Another aspect of the present invention provides a method of producing a chewing gum. The method comprises providing mulberry leaf ingredients in a form of an extract of mulberry leaf, powder of dried mulberry leaf or a mixture thereof; mixing the mulberry leaf ingredients with a gum base so as to form a chewing gum mixture; and shaping the chewing gum mixture into a predetermined shape. In the method, the extract of mulberry leaf is in a form of liquid or powder. The mixing step further comprises mixing sugar alcohol to form the chewing gum mixture. The chewing gum mixture contains substantially no sugar. The mixing step further comprises mixing one or more selected from the group selected from the group consisting of a tenderizer, a moisturizer, an emulsifier, a flavoring agent and fruit juice. The shaping comprises: rolling the mixture to form a sheet of the mixture; and cutting the sheet into a predetermined pattern. The method further comprises coating the shaped chewing gum with a sweetener. The sweetener is selected from the group consisting of xylitol, maltitol, sorbitol and isomalt.

Still another aspect of the present invention provides a method of treatment of certain conditions selected from the group consisting of lowering blood sugar level, lowering blood pressure, improving blood circulation in brain and lowering cholesterol level. The method comprises administering ingredients of mulberry leaf to a person in need of such treatment by way of chewing a chewing gum comprising the ingredients.

### DETAILED DESCRIPTION OF THE PREFERRED EMBODIMENT

The mulberry leaves contain 20-40wt % of crude protein and 24 amino acids. Among them, alanine and aspartic acid, which eliminates hangover, are contained in an amount of 3%(w/w), and serine and tyrosine, which improves blood circulation of brain and lowers cholesterol level, are contained in the amounts of 1.2%(w/w) and 0.7%(w/w), respectively. Furthermore, mulberry leaves are rich in various minerals: that is, they contain 60 times of calcium content compared to that of a cabbage, 160 times of iron and 10 times of phosphorus contents compared to those of a radish, and they contain, compared to those of green tea, 6 times of calcium, 2 times of iron, 13 times of sodium and 1.4 times of potassium, respectively.

Recent studies have reported that the leaves of mulberry contain also GABA(γ-amino butyric acid) in an amount of 250 mg per 100 g dry weight, which is known to have a potential activity of depressing blood pressure and neurotransmitter as well, and 3 times of rutin which has the activities of strengthening capillary vessel and prevention of cerebral hemorrhage and hemorrhagic disease. In addition, it is reported that DNJ(deoxynojirimycin) inhibiting the uptake of blood sugar exists only in mulberry leaves among the plants, and animal experiments further revealed that mulberry leaves also contain materials possessing biological activities of depressing blood sugar and blood pressure, lowering cholesterol level, and antioxidants and anticancer agents(see: Lee Wan-Joo et al. Kor. J. Pharm., 30(2):123-129, 1999). However, food showing the pharmacological effects of mulberry leaves has not been developed in the art yet.

The present inventor tried to develop a health food including functional ingredients of mulberry leaf to show its effects rapidly. The present inventor investigated best ways of taking the functional ingredients of the mulberry leaf. The inventor found that the form of a chewing gum comprising functional ingredients of mulberry leaf allows uptake of the ingredients in relatively great quantities and shows its effects more rapidly than other conventional foods.

The inventor further examined which forms are available for the addition of the ingredients of mulberry leaves to the chewing-gum and found that the ingredients of mulberry leaf can be added to chewing gum in a form of, although not limited thereto, dried powder of mulberry leaf, liquid extract of mulberry leaf, powder of mulberry leaf extract, or mixture thereof. Preferably, the dried leaf powder is obtained by excision of the leaves in a size less than 200 mesh. Preferably, the mulberry leaf extract obtained by extraction with ethanol and vacuum concentration. Preferably, the mulberry leaf extract powder obtained by drying the mulberry extract.

Further, the inventor noted that depression effect of blood sugar level by functional ingredients of mulberry leaf may be inhibited by sugar contained in chewing gum. In order to avoid or minimize the inhibition, sugar alcohol is preferably used to the gum instead of sugar. Alternatively, low calorie artificial sweetener may be used.

Chewing gum according to one aspect of the present invention can include one or more of the functional ingredients of mulberry leaf. For example, the chewing gum can comprise: 15-30%(w/w) of gum base, 60-80%(w/w) of sugar alcohol, 0.1-0.5%(w/w) of tenderizer, 0.1-1.0%(w/w) of moisturizer, 0.1-0.5%(w/w) of emulsifier, 0.5-2.5%(w/w) of flavoring agent, 0.01-10.0%(w/w) of one or more ingredients from mulberry leaf, and 0.1-2.0%(w/w) of concentrated fruit juice. The sugar alcohol includes, but not limited thereto, xylitol, maltitol, sorbitol and isomalt. The functional ingredients of mulberry leaf can be included in a form of, although not limited thereto, dried powder of mulberry leaf, liquid extract of mulberry leaf, powder of mulberry leaf extract, or mixture thereof. The selections of gum base, tenderizer, moisturizer, emulsifier and flavoring agent are well appreciated by an ordinary skill in the art.

The process for making the chewing gum is essentially mixing various ingredients of the chewing gum including gum base and mulberry leaf ingredients and shaping the mixture in a predetermined shape. The ingredients of the chewing gum includes, for example, 0.01-10.0(w/w) % of the functional ingredients of mulberry leaf, 15-30wt % of gum base, 60-80wt % of sugar alcohol, 0.1-0.5wt % of tenderizer, 0.1-1.0 wt % of moisturizer, 0.1-0.5wt % of emulsifier, and 0.1-2.0 wt % of concentrated fruit juice. The mixing of the ingredients is conducted preferably while heating at 50-60° C. The mixing is conducted for about 20 to about 30 minutes. A flavoring agent at about 0.5-2.5wt % is preferably added to the mixture while still heating. The chewing gum can be shaped in a variety of ways as well understood by an ordinary skill in the art. To form a strip of chewing gum, for example, the mixture is subject to rolling to form a sheet of the mixture, which is then cut in predetermined sizes.

The present invention is further illustrated in the following examples, which should not be taken to limit the scope of the invention.

### EXAMPLE 1-1

### Obtaining Mulberry Leaf Extract

1 kg of mulberry leaves were washed and dried in the shade, and steeped in 5 kg of 70%(v/v) ethanol for 4 hours, and then the resultant aqueous solution was obtained by gauze filtering. Vacuum concentration of the aqueous solution gave 500 g of mulberry leaf extract.

### EXAMPLE 1-2

### Obtaining Mulberry Leaf Extract Powder

300 g of the mulberry leaf extract obtained in Example 1-1 was subjected to freeze-drying at −30° C. to give 30 g of mulberry leaf extract powder.

### EXAMPLE 1-3

### Obtaining Mulberry Leaf Dried Powder

1 kg of mulberry leaves was washed and dried in the shadow, and then sprayed with 200 ml of sodium hydrogen carbonate solution at a concentration of 0.5%(w/v). Then, they were left to stand in a drying chamber maintaining at 75° C. for 20 minutes and cooled down to room temperature, and held at a drying chamber at 45° C. for 12 hours, to obtain dried mulberry leaves with 6%(w/w) of moisture contents per drying weight. The dried mulberry leaves thus obtained was smashed up by physical means of mortar, and then pulverized with high-speed air to obtain particle size of less than 300 mesh, by calculating the distance of the particles moved by the air stream. Then, 300 g of the mulberry leaf dried powder were obtained by passing them through magnetic bars having 200 gauss of magnetic force to remove metal components.

### EXAMPLE 2-1

### Preparation of a Chewing Gum (I)

280 g of gum base, 680 g of xylitol, 2 g of tenderizer, 3 g of moisturizer, 2 g of emulsifier, 1 g of mulberry leaf dried powder as obtained Example 1-3, 5 g of mulberry leaf extract as obtained in Example 1-1, 3 g of mulberry leaf extract power as obtained in Example 1-2, and 4 g of concentrated apple juice were mixed in a blender maintaining at 55° C. Then, to the mixture 20 g of flavoring agent was added at the same temperature, and mixed again for 25 minutes and rolled the mixture. And then, the resultant was aged at room temperature, and cut to prepare a chewing gum.

### EXAMPLE 2-2

### Preparation of a Chewing Gum(II)

A chewing-gum was prepared in a similar fashion as in Example 2-1, except for employing 3 g of mulberry leaf extract powder as obtained in Example 1-2, 3 g of mulberry leaf dried powder as obtained in Example 1-3, and 7 g of concentrated apple juice instead of adding the same components of the same amounts, while adding no mulberry leaf extract.

### EXAMPLE 2-3

### Preparation of a Chewing Gum(III)

A chewing-gum was prepared in a similar fashion as in Example 2-1, except for employing 5 g of mulberry leaf dried powder as obtained in Example 1-3, 1 g of mulberry leaf extract as obtained in Example 1-1, and 7 g of concentrated apple juice instead of adding the same components of the same amounts, while adding no mulberry leaf extract powder.

### EXAMPLE 2-4

### Preparation of a Chewing Gum(IV)

A chewing-gum was prepared in a similar fashion as in Example 2-1, except for employing 2 g of mulberry leaf extract as obtained in Example 1-1, 8 g of mulberry leaf extract powder as obtained in Example 1-2, 2 g of mulberry leaf dried powder as obtained in Example 1-3, and 1 g of concentrated apple juice instead of adding the same components of the same amounts.

### EXAMPLE 3

### Panel Test of the Chewing Gums

Chewing gums prepared in Examples 2-1 to 2-4 was tested in terms of palatability by 20 panelists. Items of the panel test were as follows: mouth feeling, bitter taste, cooling sensation, and total preference (see: Table 1).

TABLE 1
The results of panel test of chewing gums

| | Mouse | Bitter | Cooling | Total |
|---|---|---|---|---|
| Examples | feeling | taste | sensation | preference |
| 2-1 | +1.5 | No | +2.0 | +1.5 |
| 2-2 | +1.0 | No | +1.0 | +1.0 |
| 2-3 | 0 | NO | −0.7 | −0.8 |
| 2-4 | 0 | Yes | +0.2 | +0.1 |

* Scores of panel test (+2: very good; +1: good; 0: normal; −1: bad; and, −2: very bad)

As can be seen in Table 1, the chewing gum prepared in Example 2-1 was evaluated as the best one among them.

As clearly illustrated and demonstrated above, the present invention provides a chewing-gum comprising the functional ingredients of mulberry leaf allowing the uptake the ingredients of mulberry leaf in great quantities, and a process for preparing the same. The chewing gum of the invention can be practically applied for the diet food and substitute food for the patients suffering from constipation, diabetes and hypertension.

What is claimed is:

1. A chewing gum comprising:
a gum base;
mulberry leaf ingredients in a form of an extract of mulberry leaf, powder of dried mulberry leaf or a mixture thereof.

2. The chewing gum of claim 1, wherein the extract of mulberry leaf is in a form of liquid or powder, which is mixed with the gum base.

3. The chewing gum of claim 1, wherein the gum base has a weight from about 15% to about 30% of the total weight of the chewing gum.

4. The chewing gum of claim 1, wherein the mulberry leaf ingredients has a weight from about 0.01% to about 10% of the total weight of the chewing gum.

5. The chewing gum of claim 1, further comprising a sweetener.

6. The chewing gum of claim 5, wherein the sweetener is a sugar alcohol.

7. The chewing gum of claim 5, wherein the sweetener is selected from the group consisting of xylitol, maltitol, sorbitol and isomalt.

8. The chewing gum of claim 7, wherein the sugar alcohol has a weight from about 60% to about 80% of the total weight of the chewing gum.

9. The chewing gum of claim 1, wherein the chewing gum contains substantially no sugar.

10. The chewing gum of claim 1, further comprising one or more selected from the group consisting of a tenderizer, a moisturizer, an emulsifier, a flavoring agent and fruit juice.

11. The chewing gum of claim 1, wherein the mulberry leaf ingredients comprises one or more selected from the group consisting of γ-amino butyric acid (GABA), rutin and deoxynojirimycin (DNJ).

12. The chewing gum of claim 1, wherein the mulberry leaf ingredients comprises one or more selected from the group consisting of alanine, aspartic acid, serine, tyrosine, calcium, iron, phosphor, sodium and potassium.

13. A chewing gum comprising:
a gum base; and
one or more selected from the group consisting of γ-amino butyric acid (GABA), rutin and deoxynojirimycin (DNJ).

14. The chewing gum of claim 13, further comprising one or more selected from the group consisting of alanine, aspartic acid, serine, tyrosine, calcium, iron, phosphor, sodium and potassium.

15. The chewing gum of claim 13, further comprising a sweetener.

16. The chewing gum of claim 15, wherein the sweetener is a sugar alcohol.

17. The chewing gum of claim 13, wherein the chewing gum contains substantially no sugar.

18. A chewing gum comprising:
a gum base; and
means for providing functional ingredients of mulberry leaf.

19. The chewing gum of claim 18, wherein the functional ingredients comprises one or more selected from the group consisting of γ-amino butyric acid (GABA), rutin and deoxynojirimycin (DNJ).

20. The chewing gum of claim 18, wherein the functional ingredients comprises one or more selected from the group consisting of alanine, aspartic acid, serine, tyrosine, calcium, iron, phosphor, sodium and potassium.

21. The chewing gum of claim 18, further comprising a sweetener.

22. The chewing gum of claim 18, wherein the sweetener is a sugar alcohol.

23. The chewing gum of claim 18, wherein the chewing gum contains substantially no sugar.

24. A method of producing a chewing-gum, comprising:
providing mulberry leaf ingredients in a form of an extract of mulberry leaf, powder of dried mulberry leaf or a mixture thereof;
mixing the mulberry leaf ingredients with a gum base so as to form a chewing gum mixture; and
shaping the chewing gum mixture into a predetermined shape.

25. The method of claim 24, wherein the extract of mulberry leaf is in a form of liquid or powder.

26. The method of claim 24, wherein the mixing step further comprises mixing a sweetener to form the chewing gum mixture.

27. The method of claim 26, wherein the sweetener is a sugar alcohol.

28. The method of claim 24, wherein the chewing gum mixture contains substantially no sugar.

29. The method of claim 24, wherein the mixing step further comprises mixing one or more selected from the group selected from the group consisting of a tenderizer, a moisturizer, an emulsifier, a flavoring agent and fruit juice.

30. The method of claim 24, wherein the shaping comprises:
rolling the mixture to form a sheet of the mixture; and
cutting the sheet into a predetermined pattern.

31. The method of claim 24, further comprising coating the shaped chewing gum with a sweetener.

32. The method of claim 31, wherein the sweetener is selected from the group consisting of xylitol, maltitol, sorbitol and isomalt.

33. A chewing gum produced by the method of claim 24.

34. A method of treatment selected from the group consisting of lowering blood sugar level, lowering blood pressure, improving blood circulation in brain and lowering cholesterol level, the method comprising administering ingredients of mulberry leaf to a person in need of such treatment by way of chewing a chewing gum comprising the ingredients.
